(19) United States
(12) Patent Application Publication
(10) Pub. No.: US 2012/0224983 A1
(43) Pub. Date: Sep. 6, 2012

(54) MULTI-WAY VALVE, HYDRAULIC DEVICE AND CONCRETE PUMP VEHICLE

(76) Inventors: Xiaogang Yi, Hunan (CN); Yongdong Liu, Hunan (CN); Yanghui Xiang, Human (CN)

(21) Appl. No.: 13/508,954

(22) PCT Filed: Nov. 4, 2010
(86) PCT No.: PCT/CN2010/078428

§ 371 Date: May 9, 2012

(30) Foreign Application Priority Data
Nov. 10, 2009 (CN) 200920278542.X

(51) Int. Cl. F15B 15/18; E04G 21/04; F15B 13/02

(52) U.S. Cl. 417/234; 251/30.01; 137/884; 60/476

(57) ABSTRACT

A multi-way valve includes a plurality of parallel combination valves for controlling corresponding actuators (4-1-4-5). Each combination valve comprises proportional throttle valves (2-1-2-5) and reversing valves (3-1-3-5). An oil inlet of the proportional throttle valve is communicated with a main oil inlet (P), and an oil outlet of the proportional throttle valve is communicated with an oil inlet of the reversing valve. An oil outlet of the reversing valve is communicated with the main oil return port (T). Wherein, each combination valve further comprises a one-way control valve (9-1-9-5, 10-1-10-5) for obtaining the load pressure of corresponding actuator. One side of the one-way control valve is communicated with a pipeline between the proportional throttle valve and the actuator. The multi-way valve further includes a control element (8) which receives the load pressure fed back by each one-way control valve and responds to the load pressure to control the supply of hydraulic oil for the actuators. The multi-way valve has the load-sensitive function, thereby reducing energy loss and system heat productivity. A hydraulic equipment and a concrete pump vehicle corresponding to the multi-way valve are also provided.

The present application claims the priority to Chinese patent application No. 200920278542.X filed on Nov. 20, 2009 and entitled “multi-way valve, hydraulic device and concrete pump vehicle”, which is incorporated herein by reference in its entirety.

### FIELD OF THE INVENTION

The invention relates to the field of construction machinery technology, in particular to a multi-way valve, a hydraulic device and a concrete pump vehicle.

### BACKGROUND OF THE INVENTION

A multi-way valve is a core control element in construction machinery such as the arm support hydraulic device of a concrete pump vehicle, which is located between the hydraulic pump and the actuator for controlling the flow rate and direction of the hydraulic oil, so that the movement direction and speed of the actuator in the hydraulic device is central controlled and thereby the movement direction and rate of the arm support of the concrete pump vehicle is central controlled. Now the currently used concrete pump vehicle mainly uses manual control multi-way valves and electro-hydraulic proportional multi-way valves to control the movement of the arm support.

The manual control multi-way valve drives the valve core of a reversing valve to move by the force produced by operating the manual lever so as to turn on-off or switch of the oil line. Because this multi-way valve cannot be electrically automatic controlled, it is greatly limited in application.

The electro-hydraulic proportional multi-way valve has a proportional electromagnet. An electrical command signal is transferred to current that is proportionately inputted into the proportional electromagnet, the proportional electromagnet controls the valve core of the reversing valve to move in proportion to realize the control of the flow rate and direction of the hydraulic oil, therefore the change of the movement speed and direction of the actuator is controlled. The number of circuits of the multi-way valve can be increased or decreased according to the practical movement requirements. However, there are at least two oil chambers and oil ports provided in the valve body of the multi-way valve, which leads to the complex structure of the valve body and thereby increasing the manufacturing cost.

The Chinese patent of utility model No. ZL200820003735.X, which is entitled “multiple-way valve and hydraulic device and concrete pump vehicle having the same” discloses a multi-way valve, for centralized controlling at least two actuators, which comprises a plurality of combination valves provided on an integrated oil line block, wherein each combination valve comprises a proportional throttle valve 2 and a reversing valve 3; the integrated oil line block is provided with a main oil inlet P and a main oil return port T, and a working oil port communicating with the oil ports of the two actuators, wherein the oil inlet of the proportion throttle valve is communicated with the main oil inlet, and the oil outlet is communicated with the oil inlet of the reversing valve, the oil outlet of the reversing valve is communicated with the main oil return port. The multi-way valve adopts a simple integrated oil line block to combine the proportional throttle valve and the reversing valve into at least two parallel combination valves, and control the motion of the actuators by the proportion throttle valve and the reversing valve, thus the multi-way valve has the advantages of simple structure and low manufacturing cost.

The solution adopting the above multi-way valve has the defect of lacking load-sensitive function, the oil pump 6 in the multi-way valve always functions with the maximal discharge capacity under the overfall pressure set by the overflow valve 5, and it cannot match the actual load of the actuator 4 and the required flow rate, so that a lot of energy is wasted and the hydraulic system has great heat productivity.

### SUMMARY OF THE INVENTION

The object of the present invention is to provide a multi-way valve and a hydraulic device having the load-sensitive function so as to enable the flow rate to match the actual load of the actuator. Usage of the multi-way valve and the hydraulic device can reduce the energy loss and heat productivity.

According to one aspect of a multi-way valve of the present invention, a multi-way valve includes a plurality of parallel combination valves, configured to control corresponding actuators, each of the combination valves comprising a proportional throttle valve and a reversing valve connected in series, an oil inlet of the proportional throttle valve is connected to an main oil inlet, and an oil outlet of the proportional throttle valve is connected to an oil inlet of the reversing valve, an oil outlet of the reversing valve is connected to the main oil return port, the multi-way valve is characterized in that, each of the combination valve further comprising an one-way control valve, configured to obtain the load pressure of corresponding actuator, one side of the one-way control valve is connected to the pipeline between the proportional throttle valve and the actuator; the multi-way valve further comprising a control element, configured to receive the load pressure fed back by each of the one-way control valve and respond to the load pressure to control the hydraulic oil supplied to the actuators. According to the above solution, the practical load of a plurality of actuators can be transferred to the control element, and the control element provides matched flow rate and pressure according to the practical load, thereby reducing energy loss and heat productivity.

Furthermore, one side of the one-way control valve in each combination valve is connected to the pipeline between the proportional throttle valve and the reversing valve or between the reversing valve and the corresponding actuator. It is possible to collect practical load pressure on all these pipelines.

Furthermore, the one-way control valve is a one-way valve, and the oil inlet side of the one-way valve is the side for connection. Each practical pressure of oil pressure for driving the corresponding actuator can be transferred to the control element through each one-way valve. When the oil inlet side of the one-way valve is connected to the pipeline between the reversing valve and the corresponding actuator, it may be considered to connect each of the two pipelines between the two working oil ports of the reversing valve and the actuator with a one-way valve. Of course it is also equivalent to mounting a shuttle valve herein. Two oil inlets of the shuttle valve are respectively connected to these two pipelines, while the oil outlets are connected to the control element.

According to one alternative solution of the present invention, the one-way control valve is a shuttle valve, and the side of the first oil inlet of the shuttle valve is the side for connection, the oil outlet of the shuttle valve of the first combination valve of the plurality of combination valves is connected to the control element, the second oil inlet of the shuttle valve of the last combination valve is connected to an oil return port, the shuttle valves of any two adjacent combination valves are connected to each other by connecting the second oil inlet of the shuttle valve of the former combination valve with the oil outlet of the shuttle valve of the latter combination valve. Finally, it is also possible to transfer the practical load pressure of each actuator to the control element by connecting the shuttle valves of each combination valve to each other.

Furthermore, the control element is a three-way flow valve, its oil inlet is connected to the main oil inlet, and its oil return port is connected to the main oil return port, and its oil control port is connected to the oil outlet of the one-way valve or to the oil outlet of the shuttle valve of the first combination valve. It forms a load-sensitive network comprising of one-way valve or shuttle valve and three-way flow valve by providing a three-way flow valve, so that the load-sensitive function can be easily realized.

According to one improved solution of the present invention, it further comprises an integrated oil line block, on which the main oil inlets and the main oil return ports are provided, the combination valves and the three-way flow valve are mounted on the integrated oil line block. Thus the multi-way valve has the advantages of simple structure and low manufacturing costs.

According to another aspect of the present invention, a hydraulic device, comprises a hydraulic pump, a plurality of actuators and a multi-way valve provided between the hydraulic pump and the actuators, said multi-way valve including a plurality of parallel connected combination valves configured to control corresponding actuators; each of the combination valve comprising a proportional throttle valve and a reversing valve connected in series; all of oil inlets of the proportional throttle valve are connected to a main oil inlet, and all of oil outlets of the reversing valve are connected to a main oil return port. In the hydraulic device according to the present invention, each of combination valve further comprises an one-way control valve for obtaining the load pressure of corresponding actuator, one side of the one-way control valve is connected to the pipeline between the proportional throttle valve and the actuator; the hydraulic pump is a variable pump having load-sensitive control mechanism which receives the load pressure fed back by each of one-way control valve, and the variable pump responds to the load pressure to control the supply of hydraulic oil to the actuators. It is possible to provide the load matched flow rate and pressure according to the load pressure of each actuator by configuring the hydraulic pump as a variable pump in combination with the load-sensitive control mechanism of the variable pump.

The configuration of the one-way control valve is similar to that in the solution of the multi-way valve, and the difference lies in: when the solution of the one-way valve is adopted, the one-way valve is connected at the side of the oil outlet to the load-sensitive control mechanism. When the configuration of the shuttle valve is adopted, the oil outlet of the shuttle valve of the first combination valve of the plurality of combination valves is connected to the load-sensitive control mechanism.

The multi-way valve and the hydraulic device according to the present invention have the load-sensitive function, thereby effectively reducing energy loss and heat productivity of the system. The requirements of the motion of the arm support can be met by using the multi-way valve and the hydraulic device according to the above technical solutions to control the motion of the arm support of the concrete pump vehicle, and the multi-way valve and the hydraulic device have the advantages of simple structure, low production costs, low energy loss and heat productivity.

### BRIEF DESCRIPTION OF THE DRAWINGS

The accompanying drawings, which form one part of the description of the present invention and are used for thorough understanding of the present invention, show the embodiments of the present invention, and explain together with the description the principle of the present invention.

FIG. 1 shows the principle of the first implementation of the multi-way valve according to the present invention;

FIG. 2 shows the front view of the first implementation of the multi-way valve according to the present invention;

FIG. 3 shows the top view of the first implementation of the multi-way valve according to the present invention;

FIG. 4 shows the principle of the second implementation of the multi-way valve according to the present invention;

FIG. 5 shows the principle of the third implementation of the multi-way valve according to the present invention; and

FIG. 6 shows the principle of the first implementation of the hydraulic device according to the present invention.

### DETAILED DESCRIPTION OF THE PRESENT INVENTION

The present invention is further explained in the following detailed description in conjunction with the accompanying drawings. It will be apparent that the embodiments and the features in the embodiments in the present application can be combined with each other when there is no contradictory.

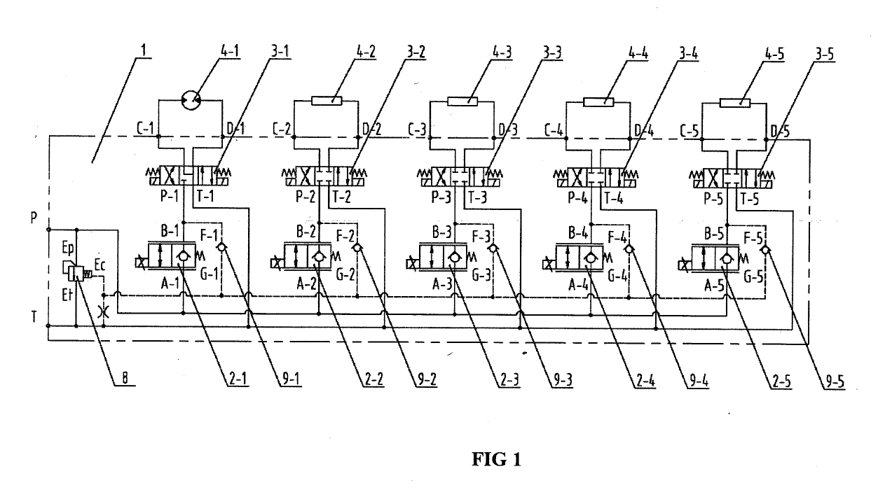

FIG. 1 shows the multi-way valve for controlling the arm support of a concrete pump vehicle according to the first implementation of the present invention. In this embodiment, the one-way control valve for obtaining the load pressure of corresponding actuators are the one-way valve 9-1-9-5, the control element which receives the load pressure fed back by each of one-way control valves and responds to the load pressure to control the supply of hydraulic oil through the main oil inlet to the actuators is a three-way flow valve 8, both the one-way control valve and the control element realize the load-sensitive function.

In particular, the multi-way valve comprises a first combination valve composed of a first electro-hydraulic proportional throttle valve 2-1, a first electromagnetic reversing valve 3-1 and a first one-way valve 9-1, a second combination valve composed of a second electro-hydraulic proportional throttle valve 2-2, a second electromagnetic reversing valve 3-2 and a second one-way valve 9-2, a third combination valve composed of a third electro-hydraulic proportional throttle valve 2-3, a third electromagnetic reversing valve 3-3 and a third one-way valve 9-3, a fourth combination valve composed of a fourth electro-hydraulic proportional throttle valve 2-4, a fourth electromagnetic reversing valve 3-4 and a fourth one-way valve 9-4, a fifth combination valve composed of a fifth electro-hydraulic proportional throttle valve 2-5, a fifth electromagnetic reversing valve 3-5 and a fifth one-way valve 9-5, as well as a three-way flow valve 8 and an integrated oil line block 1.

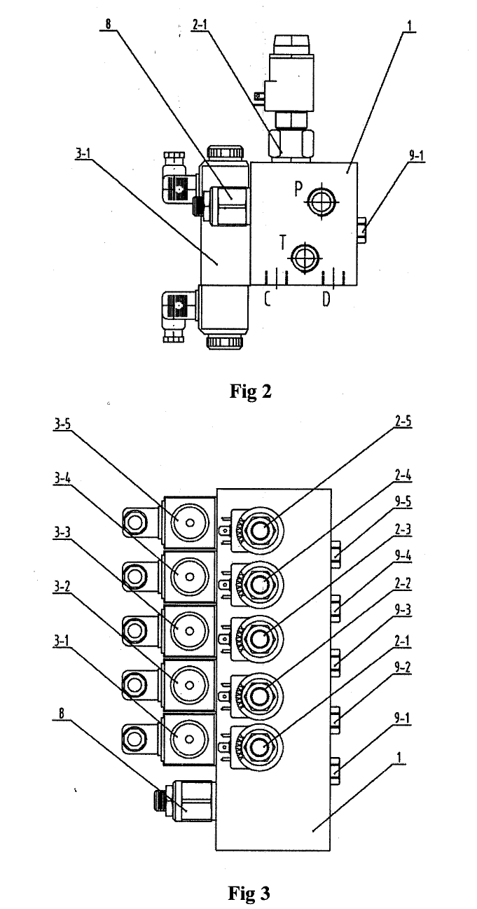

As shown in FIGS. 2 and 3, the above combination valves, the three-way flow valve 8 and the integrated oil line block 1 are threaded connected to each other, the integrated oil line block has a rectangular structure and comprises an main oil inlet P and an main oil return port T.

The three-way flow valve 8 comprises an oil inlet Ep, an oil return port Et and an oil control port Ec, in which the oil inlet Ep thereof is communicated with the main oil inlet P, and the oil return port Et is communicated with the main oil return port T.

The first electro-hydraulic proportional throttle valve 2-1 comprises an oil inlet A-1 and an oil outlet B-1, in which the oil inlet A-1 of the first electro-hydraulic proportional throttle valve 2-1 is communicated with the main oil inlet P.

Specifically, the first electromagnetic reversing valve 3-1 is a three-position four-way electromagnetic reversing valve, which comprises an oil inlet P-1, an oil outlet T-1, a first working oil port C-1 and a second working oil port D-1, the oil inlet P-1 of the first electromagnetic reversing valve 3-1 is communicated with the oil outlet B-1 of the first electro-hydraulic proportional throttle valve 2-1, and the oil outlet T-1 of the first electromagnetic reversing valve 3-1 is communicated with the main oil return port T.

The first one-way valve 9-1 comprises an oil inlet F-1 and an oil outlet G-1, in which the oil inlet F-1 thereof is communicated with the oil outlet B-1 of the first electro-hydraulic proportional throttle valve 2-1, and the oil outlet G-1 thereof is communicated with the oil control port Ec of the three-way flow valve 8.

The second electro-hydraulic proportional throttle valve 2-2 comprises an oil inlet A-2 and an oil outlet B-2, in which the oil inlet A-2 thereof is communicated with the main oil inlet P.

The second electromagnetic reversing valve 3-2 is a three-position four-way electromagnetic reversing valve, which comprises an oil inlet P-2, an oil outlet T-2, a first working oil port C-2 and a second working oil port D-2, the oil inlet P-2 of the second electromagnetic reversing valve 3-2 is communicated with the oil outlet B-2 of the second electro-hydraulic proportional throttle valve 2-2, and the oil outlet T-2 of the second electromagnetic reversing valve 3-2 is communicated with the main oil return port T.

The second one-way valve 9-2 comprises an oil inlet F-2 and an oil outlet G-2, in which the oil inlet F-2 thereof is communicated with the oil outlet B-2 of the second electro-hydraulic proportional throttle valve 2-2, and the oil outlet G-2 thereof is communicated with the oil control port Ec of the three-way flow valve 8.

The third electro-hydraulic proportional throttle valve 2-3 comprises an oil inlet A-3 and an oil outlet B-3, in which the oil inlet A-3 thereof is communicated with the main oil inlet P.

Specifically, the third electromagnetic reversing valve 3-3 is a three-position four-way electromagnetic reversing valve, which comprises an oil inlet P-3, an oil outlet T-3, a first working oil port C-3 and a second working oil port D-3, the oil inlet P-3 of the third electromagnetic reversing valve 3-3 is communicated with the oil outlet B-3 of the third electro-hydraulic proportional throttle valve 2-3, and the oil outlet T-3 of the third electromagnetic reversing valve 3-3 is communicated with the main oil return port T.

The third one-way valve 9-3 comprises an oil inlet F-3 and an oil outlet G-3, in which the oil inlet F-3 thereof is communicated with the oil outlet B-3 of the third electro-hydraulic proportional throttle valve 2-3, and the oil outlet G-3 thereof is communicated with the oil control port Ec of the three-way flow valve 8.

The fourth electro-hydraulic proportional throttle valve 2-4 comprises an oil inlet A-4 and an oil outlet B-4, in which the oil inlet A-4 thereof is connected to the main oil inlet P.

Specifically, the fourth electromagnetic reversing valve 3-4 is a three-position four-way electromagnetic reversing valve, which comprises an oil inlet P-4, an oil outlet T-4, a first working oil port C-4 and a second working oil port D-4, the oil inlet P-4 of the fourth electromagnetic reversing valve 3-4 is communicated with the oil outlet B-4 of the fourth electro-hydraulic proportional throttle valve 2-4, and the oil outlet T-4 of the fourth electromagnetic reversing valve 3-4 is communicated with the main oil return port T.

The fourth one-way valve 9-4 comprises an oil inlet F-4 and an oil outlet G-4, in which the oil inlet F-4 thereof is communicated with the oil outlet B-4 of the fourth electro-hydraulic proportional throttle valve 2-4, and the oil outlet G-4 thereof is communicated with the oil control port Ec of the three-way flow valve 8.

The fifth electro-hydraulic proportional throttle valve 2-5 comprises an oil inlet A-5 and an oil outlet B-5, in which the oil inlet A-5 thereof is communicated with the main oil inlet P.

Specifically, the fifth electromagnetic reversing valve 3-5 is a three-position four-way electromagnetic reversing valve, which comprises an oil inlet P-5, an oil outlet T-5, a first working oil port C-5 and a second working oil port D-5, the oil inlet P-5 of the fifth electromagnetic reversing valve 3-5 is communicated with the oil outlet B-5 of the fifth electro-hydraulic proportional throttle valve 2-5, and the oil outlet T-5 of the fifth electromagnetic reversing valve 3-5 is communicated with the main oil return port T.

The fifth one-way valve 9-5 comprises an oil inlet F-5 and an oil outlet G-5, in which the oil inlet F-5 thereof is communicated with the oil outlet B-1 of the fifth electro-hydraulic proportional throttle valve 2-5, and the oil outlet G-5 thereof is communicated with the oil control port Ec of the three-way flow valve 8.

The first working oil port C-1 and the second working oil port D-1 of the first electromagnetic reversing valve 3-1 are connected to two oil ports of the hydraulic motor 4-1 via oil pipelines; the first working oil port C-2 and the second working oil port D-2 of the second electromagnetic reversing valve 3-2 are connected to two oil ports of the first hydraulic cylinder 4-2 via oil pipelines; the first working oil port C-3 and the second working oil port D-3 of the third electromagnetic reversing valve 3-3 are connected to two oil ports of the second hydraulic cylinder 4-3 via oil pipelines; the first working oil port C-4 and the second working oil port D-4 of the fourth electromagnetic reversing valve 3-4 are connected to two oil ports of the third hydraulic cylinder 4-4 via oil pipelines; the first working oil port C-5 and the second working oil port D-5 of the fifth electromagnetic reversing valve 3-5 are connected to two oil ports of the fourth hydraulic cylinder 4-5 via oil pipelines.

In the following the working principle of the multi-way valve according to the first embodiment is described in detail.

The first electro-hydraulic proportional throttle valve 2-1 controls the flow area at the valve port thereof by the input electrical signal, and thereby it is possible to adjust the hydraulic oil flow rate flowing through the first electro-hydraulic proportional throttle valve 2-1 continuously and proportionally, so that the rotation speed of the hydraulic motor 4-1 can be under control.

The first electromagnetic reversing valve 3-1 has three working positions, as shown in

FIG. 1, the first phase in the middle, the second phase on the left and the third phase on the right.

When the valve core of the first electromagnetic reversing valve 3-1 is in the first phase, the valve core closes the oil inlet P-1, the oil outlet T-1, the first working oil port C-1 and the second working oil port D-1 of the first electromagnetic reversing valve 3-1, the hydraulic oil does not flow through the first electromagnetic reversing valve 3-1 and the hydraulic motor 4-1, and the hydraulic motor 4-1 keeps motionless.

When the valve core of the first electromagnetic reversing valve 3-1 is in the second phase, the hydraulic oil flows into the oil chamber of the first electromagnetic reversing valve 3-1 through the oil inlet P-1 thereof, and then flows into the hydraulic motor 4-1 through the second working oil port D-1 of the first electromagnetic reversing valve 3-1, the hydraulic oil in the hydraulic motor 4-1 flows into the oil chamber of the first electromagnetic reversing valve 3-1 through the first working oil port C-1 of the first electromagnetic reversing valve 3-1, and then flows back into the hydraulic oil tank via the oil outlet T-1 through the main oil return port T, thereby a control circuit is formed.

When the valve core of the first electromagnetic reversing valve 3-1 is in the third phase, the hydraulic oil flows into the oil chamber of the first electromagnetic reversing valve 3-1 through the oil inlet P-1 thereof, and then flows into the hydraulic motor 4-1 through the first working oil port C-1 of the first electromagnetic reversing valve 3-1, the hydraulic oil in the hydraulic motor 4-1 flows into the oil chamber of the first electromagnetic reversing valve 3-1 through the second working oil port D-1 of the first electromagnetic reversing valve 3-1, and then flows back into the hydraulic oil tank via the oil outlet T-1 through the main oil return port T, thereby a control circuit is formed.

The flow direction of the hydraulic oil flowing through the hydraulic motor 4-1 is changed by means of the above hydraulic control process and thereby the rotation direction of the hydraulic motor 4-1 is changed.

The oil inlet F-1 of the one-way valve 9-1 is communicated with the oil outlet B-1 of the first electro-hydraulic proportional throttle valve 2-1, when the valve core of the first electromagnetic reversing valve 3-1 is in the second or third phase, the oil inlet F-1 of the one-way valve 9-1 is thereby communicated with the working pressure oil chamber of the hydraulic motor 4-1, namely the one-way valve 9-1 can obtain the load pressure of the hydraulic motor 4-1 in real time; at the same time, the oil outlet G-1 of the one-way valve 9-1 is communicated with the oil control port Ec of the three-way flow valve 8, so that the control pressure of the three-way flow valve 8 is equal to the load pressure of the hydraulic motor 4-1. The oil inlet Ep of the three-way flow valve 8 is communicated with the main oil inlet P, and the oil return port Et of the three-way flow valve 8 is communicated with the main oil return port T, the three-way flow valve 8 makes the redundant flow return to the oil tank via the oil return port Et according to the actual requirements of the hydraulic motor 4-1, the main oil inlet P works under the load pressure of the hydraulic motor 4-1 and the control pressure difference of the three-way flow valve 8, when the load pressure of the hydraulic motor 4-1 varies, the pressure at the main oil inlet P changes accordingly, so that the hydraulic device having the multi-way valve has load-sensitive function, thereby effectively reduces energy loss and system heat productivity.

Similarly, other electro-hydraulic proportional throttle valves, electromagnetic reversing valves and one-way valves can realize the control of the piston motion directions and speeds of the first hydraulic cylinder 4-2, the second hydraulic cylinder 4-3, the third hydraulic cylinder 4-4 and the fourth hydraulic cylinder 4-5, and have the load-sensitive function at the same time, thereby effectively reduces energy loss and system heat productivity.

As shown in FIGS. 2 and 3, a proportional throttle valve and a reversing valve form at least two parallel combination valves by an integrated oil line block which has a simple structure and low manufacturing costs. The integrated oil line block comprises a main oil inlet P and a main oil return port T, the oil inlet of the proportional throttle valve 2 is communicated with the main oil inlet P, and the oil outlet thereof is communicated with the oil inlet of the reversing valve 3, the oil outlet of the reversing valve 3 is communicated with the main oil return port T, and the integrated oil line block also has two working oil ports C and D connected with the oil ports of the actuators. The motion speed of the actuators 4 is controlled by the proportional throttle valve 2, the motion direction of the actuators 4 is controlled by the reversing valve 3. In addition, the one-way valve and the three-way flow valve of each of the combination valve can also be mounted on the integrated oil line block.

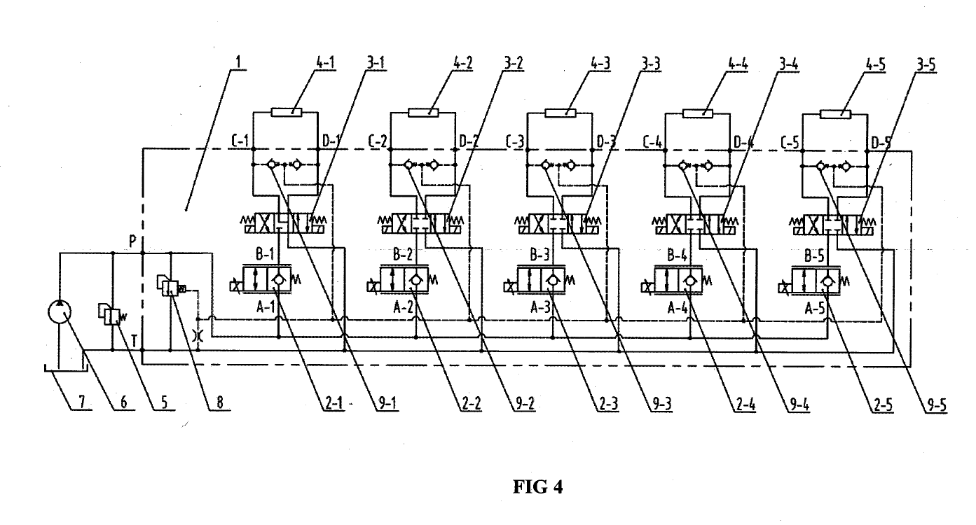

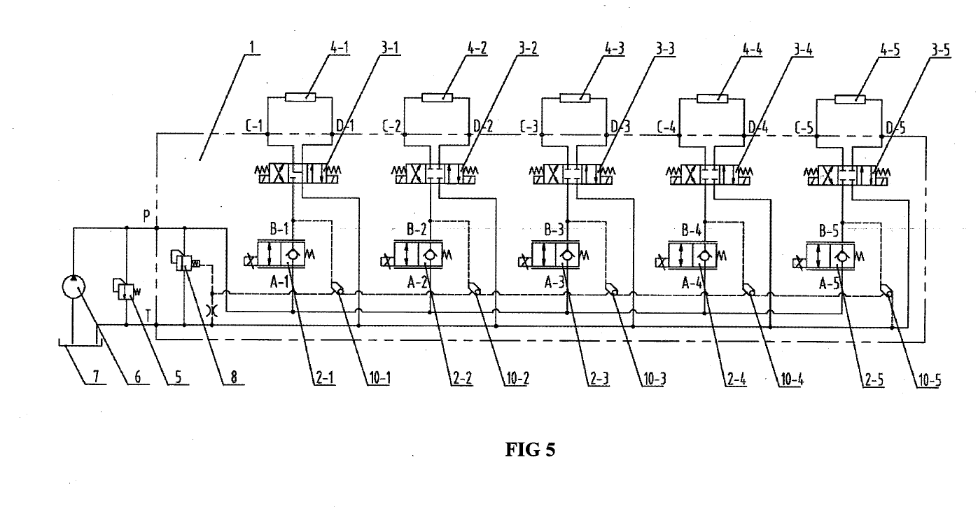

FIG. 4 shows the principle of the second embodiment of the multi-way valve according to the present invention, wherein the one-way valve 9-1-9-5 and the three-way flow valve 8 together realize the load-sensitive function. The difference from the first embodiment is, herein the oil inlets F-1-F-5 of the one-way valve 9-1-9-5 are not communicated with oil outlets B-1-B-5 of the electro-hydraulic proportional throttle valve 2-1-2-5, that is, they are not connected between the proportional throttle valve and the reversing valve, but between the reversing valve and the actuator. Herein two pipelines are provided between the two working oil ports of the reversing valve and the actuator, so a one-way valve is respectively connected to each of the pipelines, namely one-way oil inlet side. The outlets of the one-way valve are all connected to the oil control ports Ec of the three-way flow valve 8.

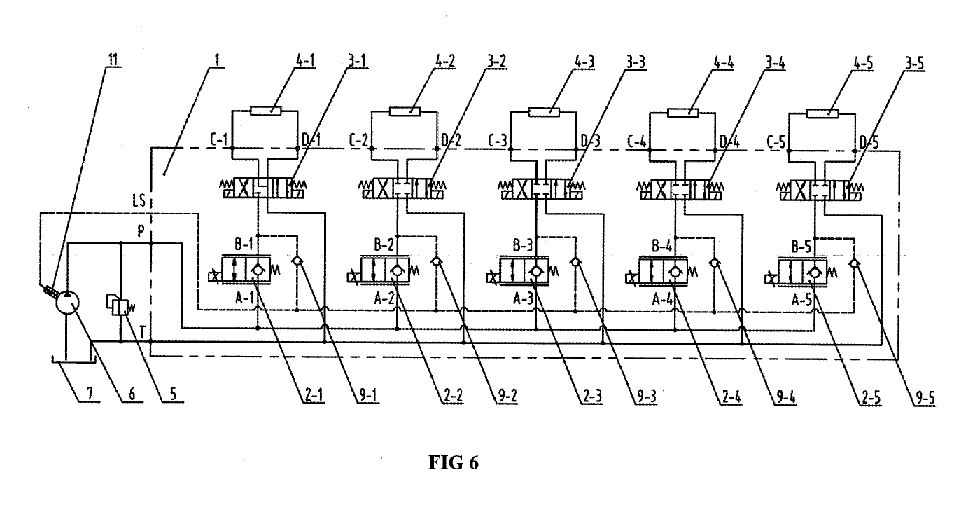

FIG. 5 shows the principle of the third embodiment of the multi-way valve according to the present invention, wherein the shuttle valve and the three-way flow valve 8 together realize the load-sensitive function instead of the one-way valve 9-1-9-5. Herein the side of the first oil inlets of the shuttle valve 10-1-10-5 are communicated with oil outlets B-1-B-5 of the electro-hydraulic proportional throttle valve 2-1-2-5, the oil outlet of the first shuttle valve 10-1 is communicated with the oil control port Ec of the three-way flow valve 8. The second oil inlet of the first shuttle valve 10-1 is communicated with the oil outlet of the second shuttle valve 10-2. The second oil inlet of the second shuttle valve 10-2 is communicated with the oil outlet of the third shuttle valve 10-3. The second oil inlet of the third shuttle valve 10-3 is communicated with the oil outlet of the fourth shuttle valve 10-4. The second oil inlet of the fourth shuttle valve 10-4 is communicated with the oil outlet of the fifth shuttle valve 10-5. The second oil inlet of the fifth shuttle valve 10-5 is connected to one oil return port, which can be the main oil return port or any oil return port that can be connected to the return oil tank.

In the above description, the embodiments of the multi-way valve of the present invention are given by taking five groups of combination valves as an example. A person skilled in the art should appreciate that the multi-way valve of the present invention can be formed by three, four or six groups of combination valves.

FIG. 6 shows the principle of the first embodiment of the hydraulic device according to the present invention. The difference between the hydraulic device and the foresaid multi-way valve having the load-sensitive function is that no three-way flow valve 8 is provided in the multi-way valve as a control element, but a variable pump 6 having a load-sensitive control mechanism 11 contained in the hydraulic device cooperates to realize the load-sensitive function. The one-way control valve 9-1-9-5 is designed similarly to that in the embodiments of the multi-way valve, namely it can be selected from one-way valve or shuttle valve, the one-way valve 9-1-9-5 or the shuttle valve 10-1-10-5 can mounted between the proportional throttle valve 2-1-2-5 and the reversing valve 3-1-3-5, or between the reversing valve 3-1-3-5 and the actuators 4-1-4-5.

Accordingly, the load-sensitive control mechanism 11 is connected to the side of the oil outlets of the one-way valve 9-1-9-5 in the embodiment shown in FIG. 6.

According to another embodiment of the hydraulic device, corresponding to the embodiment of the multi-way valve shown in FIG. 4, it is possible to connect both of the oil outlet sides of the two one-way valves of two lines connected between the reversing valve 3-1-3-5 and the actuators 4-1-4-5 to the load-sensitive control mechanism 11.

According to another embodiment of the hydraulic device, corresponding to the embodiment of the multi-way valve shown in FIG. 5, herein, the first oil inlet side of the shuttle valve 10-1-10-5 are communicated with oil outlets B-1-B-5 of the electro-hydraulic proportional throttle valve 2-1-2-5, the oil outlet of the first shuttle valve 10-1 is connected to the load-sensitive control mechanism 11. The second oil inlet of the first shuttle valve 10-1 is connected to the oil outlet of the second shuttle valve 10-2. The second oil inlet of the second shuttle valve 10-2 is connected to the oil outlet of the third shuttle valve 10-3. The second oil inlet of the third shuttle valve 10-3 is connected to the oil outlet of the fourth shuttle valve 10-4. The second oil inlet of the fourth shuttle valve 10-4 is connected to the oil outlet of the fifth shuttle valve 10-5. The second oil inlet of the fifth shuttle valve 10-5 is connected to one oil return port, which can be the main oil return port or any oil return port that can be connected to the return oil tank.

At the same time a one-way valve 9 (or shuttle valve) is used to obtain the load pressure of the actuator 4 to transfer it to the three-way flow valve 8 (or a load-sensitive control mechanism of a variable pump). The three-way flow valve 8 (or the variable pump) supplies the required flow rate according to the practical requirements of the actuator 4, the oil pump 6 works under the load pressure of the actuator 4 and the control pressure difference of the three-way flow valve 8 (or a load-sensitive control mechanism of a variable pump), so that the energy loss and system heat productivity of the hydraulic system having the hydraulic device are effectively reduced.

The above-described preferred embodiments of the invention are presented for purposes of illustration and not of limitation. It is to be noted that various changes and modifications will become apparent to those skilled in the art. Such changes and modifications are to be understood as being included within the scope of the invention.

### LIST OF REFERENCE NUMERALS

1 integrated oil line block
2-1-2-5 the first, second, third, fourth, fifth electro-hydraulic proportional throttle valve
3-1-3-5 the first, second, third, fourth, fifth reversing valve
4-1 hydraulic motor
4-2-4-5 the first, second, third, fourth hydraulic cylinder
5 overfall valve
6 variable pump
7 oil tank
8 three-way flow valve
9-1-9-5 the first, second, third, fourth, fifth one-way valve
10-1-10-5 the first, second, third, fourth, fifth shuttle valve
11 load-sensitive control mechanism

1. A multi-way valve comprising a plurality of parallel combination valves for controlling corresponding actuators (4-1-4-5), each of the combination valve comprises proportional throttle valves (2-1-2-5) and reversing valves (3-1-3-5), an oil inlet of the proportional throttle valve is connected to an main oil inlet (P), and an oil outlet of the proportional throttle valve is connected to an oil inlet of the reversing valve, an oil outlet of the reversing valve is connected to a main oil return port (T), characterised in that each of the combination valve further comprises one-way control valves (9-1-9-5, 10-1-10-5) for obtaining the load pressure of the corresponding actuator, one side of the one-way control valve is connected to a pipeline between the proportional throttle valve and the actuator, the multi-way valve further comprises a control element (8) for receiving the load pressure fed back by each of the one-way control valve and responding to the load pressure to control the supply of hydraulic oil to the actuators.

2. The multi-way valve according to claim 1, characterised in that, one side of the one-way control valves (9-1-9-5, 10-1-10-5) in each of the combination valve is connected to a pipeline between the proportional throttle valves (2-1-2-5) and the reversing valves (3-1-3-5) or between the reversing valve and the corresponding actuators (4-1-4-5) respectively.

3. The multi-way valve according to claim 2, characterised in that, the one-way control valves are one-way valves (9-1-9-5) and the side of the oil inlets (F-1-F-5) of the one-way valve is the side for connection.

4. The multi-way valve according to claim 2, characterised in that, the one-way control valves are shuttle valves (10-1-10-5) and the side of the first oil inlet of the shuttle valves is the side for connection, the oil outlet of the shuttle valve (10-1) of the first combination valve of the plurality of combination valves is connected to the control element (8), the second oil inlet of the shuttle valve (10-5) of the last combination valve is connected to an oil return port, the shuttle valves of any two adjacent combination valves are connected to each other by connecting the second oil inlet of the shuttle valve of the former combination valve to the oil outlet of the shuttle valve of the latter combination valve.

5. The multi-way valve according to claim 3, characterised in that, the control element is a three-way flow valve (8), its oil inlet (Ep) is connected to the main oil inlet (P), and its oil return port is connected to the main oil return port (T), and its oil control port (Ec) is connected to the oil outlets (G-1-G-5) of the one-way valve or to the oil outlet of the shuttle valve (10-1) of the first combination valve.

6. The multi-way valve according to claim 5, characterised in, further comprising an integrated oil line block (1), on which the main oil inlet (P) and the main oil return port (T) are provided, and on which the combination valve and the three-way flow valve (8) are mounted.

7. A hydraulic device, comprising a hydraulic pump, and an actuator configured to be a hydraulic motor or a hydraulic cylinder, and a multi-way valve according to claim 1 provided between the hydraulic pump and the actuator.

8. A hydraulic device, comprising a hydraulic pump (6), a plurality of actuators and a multi-way valve provided between the hydraulic pump and the actuators, said multi-way valve comprising a plurality of parallel combination valves, each of the combination valves configured to control corresponding actuators (4-1-4-5); each of the combination valves comprising proportional throttle valves (2-1-2-5) and reversing valves (3-1-3-5) connected in series, the oil inlets of the proportional throttle valve being connected to a main oil inlet (P), and the oil outlets thereof being connected to the oil inlets of the reversing valve, the oil outlets of the reversing valve being connected to a main oil return port (T), characterized in that each of the combination valves further comprising one-way control valves (9-1-9-5, 10-1-10-5) for obtaining the load pressure of corresponding actuator, one side of the one-way control valve is connected to a pipeline between the proportional throttle valve and the actuator, the hydraulic pump is a variable pump (6) having a load-sensitive control mechanism (11), the load-sensitive control mechanism (11) receives the load pressure fed back by each of the one-way control valve, and the variable pump (6) responds to the. load pressure to control the supply of hydraulic oil to the actuators.

9. The hydraulic device according to claim 8, characterised in that, one side of each of the one-way control valves (9-1-9-5, 10-1-10-5) in each of the combination valves is connected to a pipeline between the proportional throttle valves (2-1-2-5) and the reversing valves (3-1-3-5) or between the reversing valve and the corresponding actuators (4-1-4-5) respectively.

10. The hydraulic device according to claim 9, characterised in that, the one-way control valves are one-way valves (9-1-9-5) and the side of the oil inlets (F-1-F-5) of the one-way valve is the side for connection, the side of the oil outlets (G-1-G-5) is connected to the load-sensitive control mechanism (11).

11. The hydraulic device according to claim 9, characterised in that, the one-way control valves are shuttle valves (10-1-10-5) and the side of the first oil inlet of the shuttle valves is the side for connection, the oil outlet of the shuttle valve (10-1) of the first combination valve of the plurality of combination valves is connected to the load-sensitive control mechanism (11), the second oil inlet of the shuttle valve (10-5) of the last combination valve is connected to an oil return port, the shuttle valves of any two adjacent combination valves are connected to each other by connecting the second oil inlet of the shuttle valve of the former combination valve with the oil outlet of the shuttle valve of the latter combination valve.

12. A concrete pump vehicle, characterised in that, comprising the multi-way valve according to any one of claims 1-6 or the hydraulic device according to claim 7.
